(19) United States
(12) Patent Application Publication
(10) Pub. No.: US 2012/0306621 A1
(43) Pub. Date: Dec. 6, 2012

(54) LIGHTING CONTROL NETWORK CONFIGURATION WITH RFID DEVICES

(75) Inventor: Subramanian Muthu, Portland, OR (US)

(73) Assignee: LEVITON MANUFACTURING CO., INC., Melville, NY (US)

(21) Appl. No.: 13/153,139

(22) Filed: Jun. 3, 2011

(51) Int. Cl. G06K 7/01; G08B 5/22

(52) U.S. Cl. 340/8.1; 340/10.5; 340/6.1

(57) ABSTRACT

A networked lighting control device may include an RFID tag device to couple the lighting control device to an RFID reader device on a mobile unit. In some embodiments, the RFID tag device may enable the lighting control device to perform one or more configuration operations in response to the mobile unit. The configuration operations may include reading the RFID tag device with an RFID reader device in a mobile unit, determining the location of the networked lighting control device at the mobile unit, and displaying the location of the networked lighting control device at the mobile unit. In other embodiments, the RFID tag device may operate as part of a lighting control network.

### BACKGROUND

During the installation and commissioning of a networked lighting control system, device setup, discovery, address assignment, location identification, and the like, consume significant amounts of time and manual work. A commissioning agent needs to identify the various devices in a floor plan, and manually set up a unique address for each node or device, typically by setting DIP switches on each device.

Nodes are set up with node identifiers or addresses during the installation and commissioning process, but if the same address is inadvertently allocated to two different devices, both devices become inoperable. This condition is typically not discovered until all of the devices are installed, and it takes a significant amount of time and manual labor to identify the devices with the same address and resolve the issue by assigning two separate addresses.

Automatic address allocation techniques exist, however, the algorithms used for these techniques are complex and difficult to manage because a unique address must be generated and verified for each device on the network. Moreover, the complexity increases disproportionately as the number of devices on the network increases.

During installation, the commissioning agent uses a (typically) paper floor plan to mark the device locations with their respective addresses and uses this information to group the devices into their respective control locations. For example, an occupancy sensor in a room must be manually grouped with the lights it controls in the room. This process is labor intensive and is also prone to mistakes. Moreover, it is also time consuming to add devices to an existing floor plan once it is completed.

Testing and troubleshooting the devices in a lighting control network are also time consuming processes that involve a significant amount of manual labor. The commissioning agent typically needs to identify the devices in a specific room through building layout documents, then walk to the room and trouble shoot the devices in that room. Master (central) controllers are typically located in electrical closets or behind ceilings, and it is often necessary to connect a user input device to the master controller or other device which, in turn, requires opening the controller or other device and connecting the user input to the device.

### SUMMARY

A networked lighting control device may include lighting control apparatus, a controller to control the operation of the lighting control apparatus, a network interface to couple the controller to a lighting control network, and an RFID tag device to couple the controller to an RFID reader device.

The networked lighting control device may also include logic to perform a visual indication process in response to a request received by the RFID tag device. The visual indication process may include flashing a light controlled by the networked lighting control device, or flashing an indicator on the networked lighting control device.

The networked lighting control device may further include logic to store location identification information received through the RFID tag device, and logic to transmit the location identification information to a master controller through the network interface.

The networked lighting control device of claim may further include logic to read a unique identifier (UID) from the RFID tag device, and transmit the UID to a master controller through the network interface. The logic may also receive a network address from the master controller through the network interface in response to the UID. The networked lighting control device may also include logic to receive and use commissioning information through the RFID tag device.

The networked lighting control device may include an occupancy sensor, and the lighting control apparatus may include one or more sensor circuits. The networked lighting control device may include an electronic ballast, and the lighting control apparatus may include an input stage and an inverter.

A method for configuring a networked lighting control system may include providing a networked lighting control device having a network interface and an RFID tag device, reading the RFID tag device with an RFID reader device in a mobile unit, determining the location of the networked lighting control device at the mobile unit, and displaying the location of the networked lighting control device at the mobile unit.

The location of the networked lighting control device may be determined automatically, for example, by using a GPS unit. Alternatively, the location of the networked lighting control device may be determined manually, for example, by an operator entering location information. The method may further include transmitting a request for a location identification process to the networked lighting control device through RFID reader device and the RFID tag device. The method may further include enabling a user to correct the location of the networked lighting control device at the mobile unit in response to the location identification process. The method may further include transmitting corrected location identification information to the networked lighting control device through the RFID reader device and the RFID tag device. The method may further include transmitting the corrected location identification information to a master controller through the network interface on the networked lighting control device.

A system may include a lighting control network, a master controller coupled to the network to control network traffic and configuration, one or more RFID nodes coupled to the network, each RFID node including an RFID reader device, and one or more networked lighting control devices, each networked lighting control device including an RFID tag device to establish an RF connection with a corresponding RFID reader device at one of the RFID nodes, wherein the RF connection between each RFID tag device and a corresponding RFID reader device is configured to operate as part of the lighting control network.

The at least one of the networked lighting control devices may be configured to perform a configuration operation by communicating with an RFID reader device on a mobile unit through its RFID tag device. Alternatively, at least one of the networked lighting control devices may include a second RFID tag device, and the at least one of the networked lighting control devices may be configured to perform a configuration operation by communicate with an RFID reader device on a mobile unit through the second RFID tag device.

### BRIEF DESCRIPTION OF THE DRAWINGS

FIG. 1 illustrates an embodiment of a networked lighting control device 10 according to some inventive principles of this patent disclosure.

FIG. 2 illustrates an example embodiment of a networked lighting control system according to some inventive principles of this patent disclosure.

FIG. 3 illustrates an exemplary embodiment of a networked lighting control device according to some inventive principles of this patent disclosure.

FIG. 4 illustrates an exemplary embodiment of a handheld unit according to some inventive principles of this patent disclosure.

FIG. 5 illustrates a screen shot generated by an example embodiment of configuration software for a networked lighting control system according to some inventive principles of this patent disclosure.

FIG. 6 illustrates another embodiment of a lighting control system according to some inventive principles of this patent disclosure.

### DETAILED DESCRIPTION

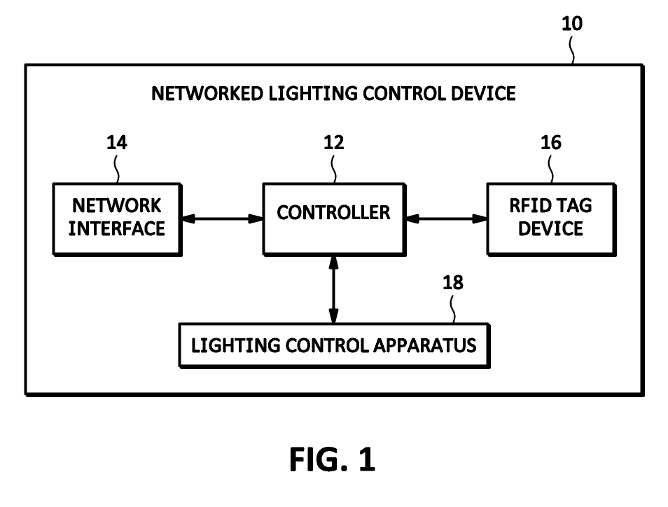

FIG. 1 illustrates an embodiment of a networked lighting control device 10 according to some inventive principles of this patent disclosure. The device 10 includes a controller 12, a network interface 14, a radio frequency identification (RFID) tag device 16, and lighting control apparatus 18. The networked lighting control device 10 may include an occupancy sensor, photocell, switch station, power pack, ballast, timer, dimmer, ceiling fan, exhaust fan, power shade, relay or relay cabinet, master controller, local controller, or any other device that may be connected to a lighting control network.

The network interface 14 may include an interface for any suitable wired or wireless network that may be used to implement a lighting control network including Control Area Network (CAN), Digital Addressable Lighting Interface (DALI), LonWorks, Modbus, ZigBee, X10, Luma-Net, SectorNET, LevNet, etc.

The lighting control apparatus 18 includes any apparatus for implementing the lighting control device 10. For example, if the device 10 is an occupancy sensor, the apparatus 18 may include one or more sensor circuits that utilize passive infrared (PIR) and/or ultrasound technology, a controller that controls the operation of the device, and one or more LED indicators that provide feedback on the operation of the device. As another example, if the device 10 is an electronic ballast for a fluorescent lamp, the apparatus 18 may include an input stage with power factor correction (PFC), an inverter stage, and dimming control circuitry.

The controller 12 may be implemented with analog and/or digital hardware, software, firmware, or any suitable combination thereof. In many embodiments, the controller may include a microcontroller or other microprocessor-based digital circuitry suitable for controlling the operation of the networked lighting control device 10 and interfacing with the RFID tag device 16.

The RFID tag device 16 refers to a low cost, low power device, such as an integrated circuit, generally intended for identification and tracking, that is suitable for use in a mass-produced RFID tag, and that responds to being interrogated by an RFID reader. The RFID tag device 16 includes an RF interface for communicating with an RFID reader through an antenna, and a controller interface for communicating with the controller 12. Thus, the RFID tag device may act as a bridge between an RFID reader and the controller. The RFID tag device also includes a unique identifier (UID). Although the inventive principles are not limited to any specific RFID tag devices, some suitable examples are the UCODE G2iM and G2iM+ devices from NXP Semiconductors N.V.

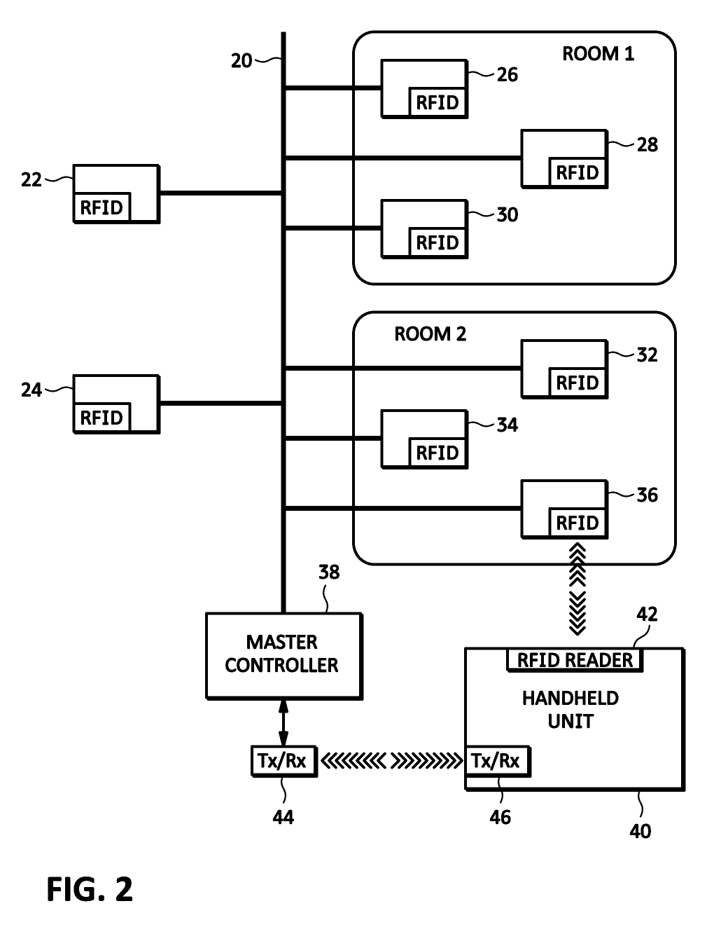

FIG. 2 illustrates an example embodiment of a networked lighting control system according to some inventive principles of this patent disclosure. The embodiment of FIG. 2 includes a network 20 that interconnects various networked lighting control devices 22, 24, 26, 28, 30, 32, 34 and 36, some or all of which include RFID tag devices indicated by the label “RFID.” A master controller 38 is connected to the network and controls the network traffic, configuration, commissioning, etc. A handheld or mobile unit 40 includes an RFID reader 42 that is capable of interrogating the RFID tag devices. The handheld unit 40 may communicate with the master controller 38 directly through wireless transceivers 44 and 46. In other embodiments, the handheld unit 40 may communicate with the master controller 38 through the lighting control nodes using the RFID tag devices, in which case, the link provided by the wireless transceivers 44 and 46 may be omitted. For example, a message from the handheld unit 40 may be transmitted to an RFID tad device in one of the lighting control devices 36, which then forwards the message to the master controller 38 through the network 20.

The networked lighting control devices may be implemented as any type of device that may be connected to a lighting control network such as those described above with respect to FIG. 1. Likewise, the network 20 may be realized as any suitable wired or wireless network that may be used to implement a lighting control network as those described above with respect to FIG. 1.

The networked lighting control devices may be located at any suitable location within a building premises, such as within Room 1 and Room 2 as shown in FIG. 2, as well as other locations such as hallways, open areas within a building, outdoor spaces on the premises, etc.

The handheld or mobile device 40 may be implemented as a dedicated hand-held unit, notebook, netbook or laptop computer, smart phone, tablet computer, or any other computing device that is mobile enough to position within range of the RFID tag devices. Wireless transceivers 44 and 46 may be implemented with any suitable technology including WiFi, Bluetooth, WiMax, ZigBee, etc.

The master controller 38 may be implemented with any suitable networked device that is capable of controlling the network traffic, configuration, commissioning, etc., of the system. Some examples include a dedicated, stand-alone control unit, a control module located within a relay cabinet, a computer workstation running a networked lighting control program, etc.

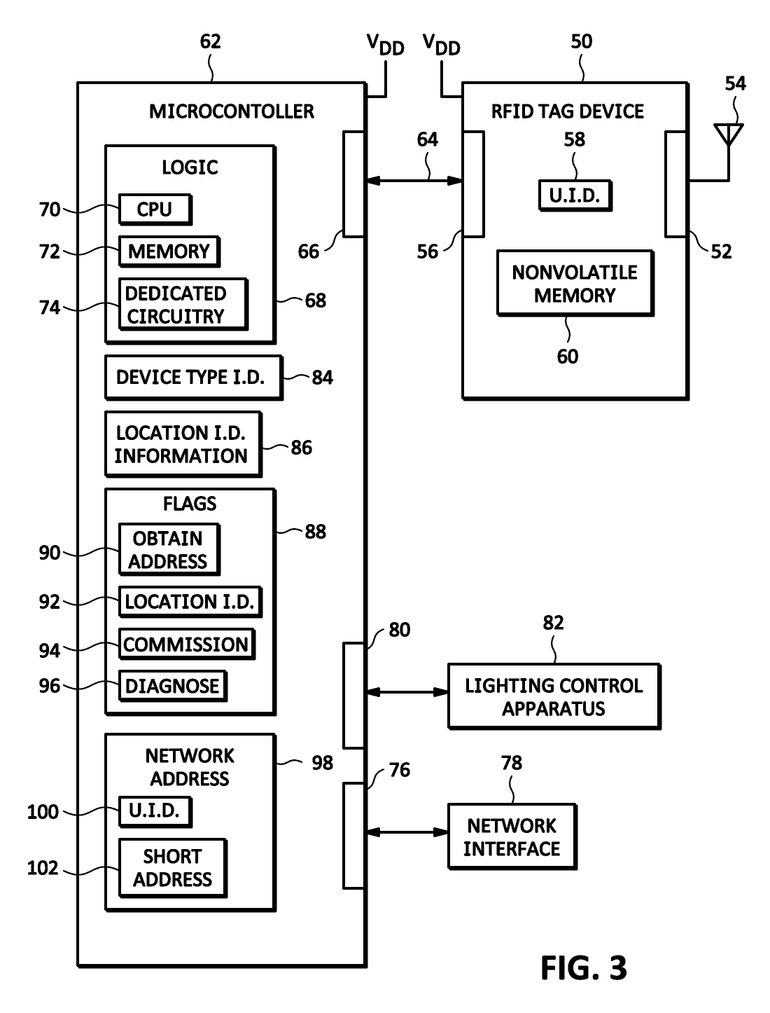

FIG. 3 illustrates an exemplary embodiment of a networked lighting control device suitable for use with the embodiments of FIGS. 1 and 2 according to some inventive principles of this patent disclosure. The networked lighting control device 10 of FIG. 3 will be described in the context of some example implementation details, but the inventive principles are not limited to these details.

The device 10 includes an RFID tag device 50 having an RF interface 52 for an antenna 54 that couples the RFID tag device to an RFID reader. A standard interface 56 such as a serial peripheral interface (SPI) or Inter-Integrated Circuit (I²C) port which interfaces the RFID tag device to a microcontroller 62 through a serial link 64. The RFID tag device also includes a unique identifier (UID) 58 and some nonvolatile user memory 60. The RFID tag device obtains power from a power supply V_{DD} within the networked lighting control device. An example device suitable for the RFID tag device is a UCODE I²C device from NXP Semiconductors N.V.

The microcontroller 62 includes a standard interface 66 for the serial link 64. The microcontroller can access (read and write) the user memory 60 in the RFID tag device through the serial link 64. Logic 68 includes a CPU 70, memory 72 and dedicated circuitry 74 to enable the microcontroller to perform all of its functions. A network interface port 76 enables the microcontroller to communicate with a network through a network interface 78 which may connect the lighting control device to a lighting control network such as network 20 shown in FIG. 2. Control interface circuitry 80 may include analog and/or digital I/O lines, timers, counters, etc., to interface with the lighting control apparatus 82 that is implemented by the lighting control device 10 such as occupancy sensing apparatus, relay switching apparatus, photocell apparatus, etc. Any or all of the standard interface 66, network interface port 76, and/or control interface circuitry 80 may be part of the microcontroller's dedicated circuitry 74. The microcontroller obtains power from a power supply V_{DD} which is shown as the same power supply for the RFID tag device, but the microcontroller may operate from a different power supply.

The microcontroller also includes nonvolatile storage for various information associated with the operation of the networked lighting control device 10. A device type identifier 84 indicates whether the networked lighting control device is an occupancy sensor, digital switch, ballast, relay, etc. The device type identifier may also include additional information about the device. For example, if the device is a ballast, the device type identifier may indicate whether it is a dimming ballast, how many lamps it controls, etc. If the device is a digital wall switch station, the device type identifier may specify how many switches, sliders, etc., the station has, how many indicator LEDs, it has, whether the switches are momentary action or toggle, etc.

Location identification information 86 indicates the location of the networked lighting control device within a building and/or room, etc. Flag storage 88 includes flags 90, 92, 94 and 96 that tell the networked lighting control device to execute various functions such as obtaining a network address, perform a location identification process, commission the device, and/or enter a troubleshooting mode, respectively.

Network address storage 98 includes storage for the UID which may be obtained from the RFID tag device if the UID is to be used directly as the network address. Short address storage 102 may be used to store a shortened network address which may be assigned, for example, by a master controller after receiving the UID for the networked lighting control device.

Any of the storage may be implemented in the memory 72, dedicated circuitry 74 or in any other suitable manner including external to the microcontroller 62.

The microcontroller 62 and RFID tag device 50 may be fabricated on a common circuit board or module, or it may be placed on a separate component. For example, the microcontroller, the RFID tag device, and the antenna for the RFID tag device may be assembled on the same circuit board if the circuit board will be housed in a plastic enclosure that does not interfere with the RF communication. Alternatively, the RFID tag device and/or antenna may be located in a plastic cover for a networked lighting control device such as a digital wall switch. With an occupancy sensor, the RFID tag device and/or antenna may be placed on a circuit board or inside the shell if the shell is made of plastic. Otherwise, the shell is made of metal or has a conductive film, the RFID tag device and/or antenna may be placed outside the metal shell, in which case the RFID tag device may be isolated from the other electronics with opto-isolators and can be powered by isolated power supplies.

In some embodiments, the power for both the microcontroller, the RFID tag device and the lighting control apparatus may be obtained from the surrounding environment. For example, some low power wireless occupancy sensors, such as those that comply with the Enocean standards, derive all of their power by harvesting photovoltaic energy, mechanical vibrations, thermal gradients, etc., to generate enough electric power to operate the entire occupancy sensor without batteries or wired connections to a power supply. This may create a synergistic combination with the RFID tag device because many RFID tag devices are capable of operating solely on the energy transmitted to the device through the antenna. Alternatively, some of the power for the RFID tag device may be obtained as surplus from the energy harvesting apparatus used for the microcontroller or other control circuitry. Thus, a low cost and/or extremely low power lighting control device may be realized that operates entirely, or mostly on energy harvested from its environment.

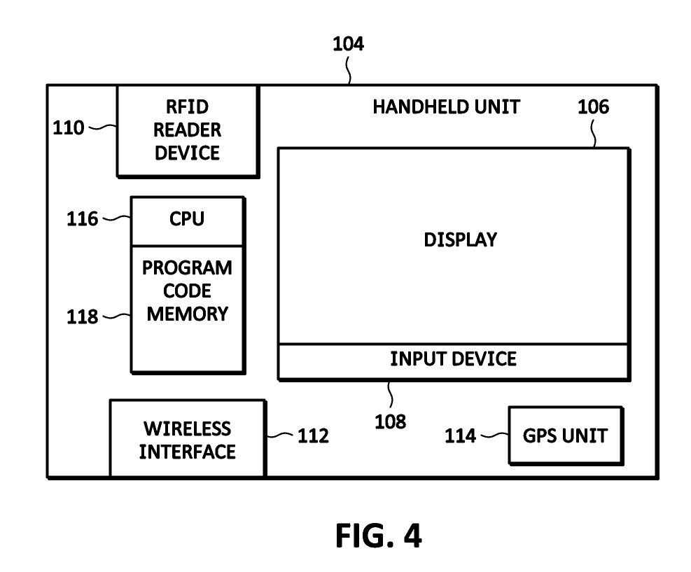

FIG. 4 illustrates an exemplary embodiment of a handheld unit suitable for use with the embodiments of FIGS. 1 and 2 according to some inventive principles of this patent disclosure. The handheld unit 40 of FIG. 4 will be described in the context of some example implementation details, but the inventive principles are not limited to these details.

The handheld unit 40 includes a display 106 and input device 108 which may include a keypad, touchpad, touch screen overlay for the display, or any other suitable apparatus for receiving user input at the handheld unit.

An RFID reader device 110 enables the handheld unit to interrogate and communicate with RFID tag devices on the networked lighting control devices. An example of a suitable RFID reader is the AS3910 from austriamicrosystems AG.

A wireless transceiver 112 enables the handheld unit to communicate with a master controller or other device. The wireless transceiver may be implemented with any suitable technology such as those described above with respect to FIG. 2.

A global positioning system (GPS) unit 114 enables the handheld unit to automatically determine its location, and therefore the location of a networked lighting control device, if held close enough to the device.

The handheld unit also includes a CPU 116 and program code memory 118 for storing configuration software that the CPU may run to implement various features as described below.

The operation of a complete exemplary system will be described with reference to the embodiments of FIGS. 1-4. For purposes of illustration, the network 20 shown in FIG. 2 is assumed to be a wired network such as CAN or SectorNET, and the wireless connection between the master controller 38 and handheld units 40 is assumed to be a WiFi connection, but the inventive principles are not limited to these or any of the other exemplary details described below.

The exemplary system uses the RFID tag devices with bi-directional communication at each lighting node to enable automatic device addressing, location identification and/or simplified diagnostics and troubleshooting using a handheld unit with an RFID reader device.

According to the inventive principles, the UID in each RFID tag device can be used for network addressing in a manner similar to the use of a MAC address for an Ethernet network. This may reduce the cost of each networked lighting control device because the unique identifiers can be purchased commercially at low cost, thereby eliminating the need for the lighting control device to generate, and assure the uniqueness of, identification numbers.

When requested by the RFID reader device on the handheld unit, the RFID tag device on a lighting control device transmits its UID to the handheld unit along with any other information stored in the user memory in the RFID tag device. The handheld unit may also transmit data to the tag device which stores the data in the user memory. The microcontroller in the lighting control device can then access this data and use it to execute various functions.

During manufacturing, the microcontroller in a networked lighting control device may be provided with a device type identifier 84 which it may then store in the memory 60 of the RFID tag device. When the RFID tag device is read by a reader in a handheld unit, it transmits this device type identifier to the handheld unit.

When the networked lighting control devices are installed, they are wired to the network without any address settings. When the installation is complete, one of the devices may be assigned as the master controller if there is no dedicated master controller in the installation. The master controller may be assigned manually by the commissioning agent, or it may be selected automatically by the type of device.

When each networked lighting control device is powered up for the first time, it looks for a network interface and the presence of a master controller. If a master controller exists on the network, it sends its UID to the master controller. The master controller then stores the UID in its own nonvolatile memory, then assigns an equivalent short ID to the lighting control device. The short ID is stored in nonvolatile memory at both the master controller and the networked lighting control device. On subsequent power ups, each device reads the short ID address from its memory and uses it for communication on the network. Thus, the UID in each networked lighting control device can be used to eliminate the manual operations associated with obtaining network addresses such as setting DIP switches.

The handheld unit may be loaded with configuration software that reads the building layout, correlates the position of the handheld unit using the GPS unit, and displays the appropriate location on the handheld display. If the GPS unit is not functioning or is not present in the particular handheld unit, the software allows the user to manually navigate through the building layout to provide the location of the handheld unit.

The configuration software also interacts with the RFID reader device and is capable of reading the UID of multiple RFID tag devices. By sending a request to each individual tag, or broadcasting a request to all tags in range, the RFID reader device in the handheld unit can read the UID and device type identifier from each RFID tag device. The RFID reader device then passes this information to the configuration software. The configuration software displays a graphic of the building layout, and can display an icon for each networked lighting control device based on the device type identifier for each device. The configuration software may also provide an option to place each icon at the appropriate location, such as a specified room, in the layout.

When multiple networked lighting control devices are found within range of the handheld unit, the configuration software may display an icon for each device and provides an option to identify the device associated with each icon. When the user selects or activates an icon for a device, the software causes the RFID reader device to transmit an identification flag to the selected networked lighting control device. The identification flag may be transmitted to the memory in the RFID tag device, or directly to the microprocessor using the RFID tag device as a communication bridge. If the flag is transmitted to the memory in the RFID tag device, the microcontroller may periodically poll the memory and retrieve the flag.

When the identification flag is asserted, the microcontroller executes a location identification process by activating some type of visual and/or audible indication. For example, if the lighting control device is a ballast, it may flash the lamp or lamps that it controls. As another example if the lighting control device is an occupancy sensor or digital switch station, it may flash an LED or any other type of visible indicator that may exist on the lighting control device. Upon seeing the visual indication from the networked lighting control device, the user may then move the icon for the lighting control device to the correct location on the graphic layout. Once the icon is in the correct location, the configuration software passes appropriate location identification information to the networked lighting control device through its RFID tag device. The microcontroller in the lighting control device then reads the location identification information and transmits it to the master controller through the wired lighting control network, which stores the location identification information for that lighting control device in its local nonvolatile memory. Alternatively, the handheld unit may transmit the location identification information directly to the master controller through the WiFi connection.

The same processes described above may also be used to easily add or remove devices once the installation has been completed and address assignment, location identification and commissioning processes are finished.

A computer workstation having configuration software with similar capabilities may be connected to the master controller. The workstation may then be used to process location identification information and display the locations of the networked lighting control devices in the appropriate locations on the building layout.

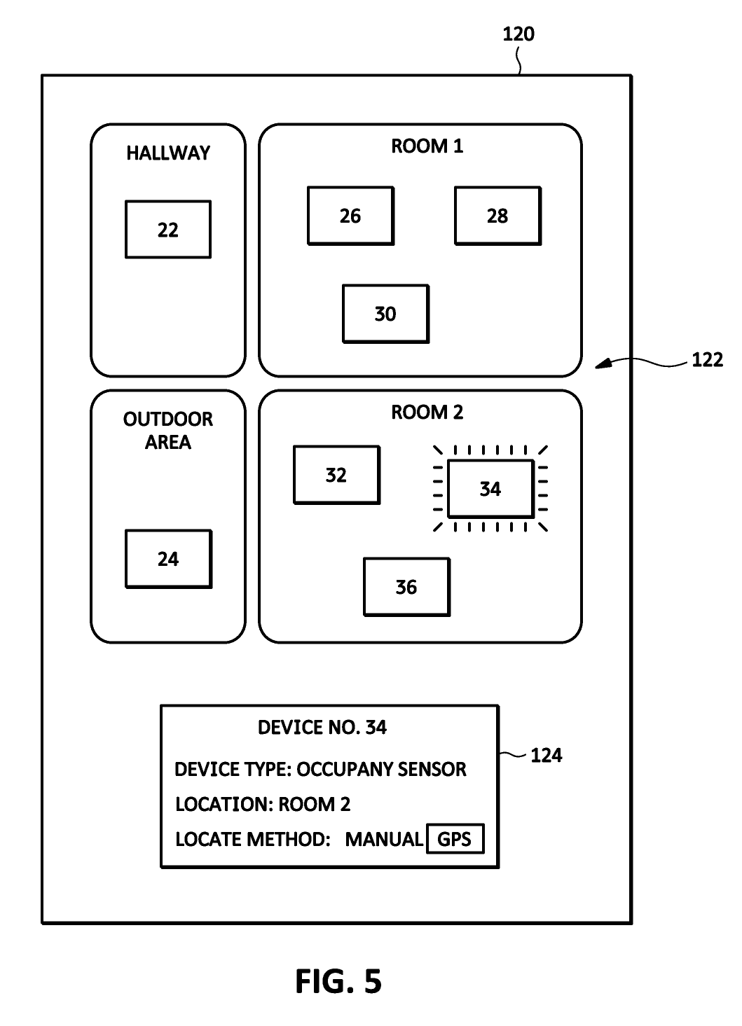

FIG. 5 illustrates a screen shot generated by an example embodiment of configuration software for a networked lighting control system according to some inventive principles of this patent disclosure. The screenshot 120 includes a building layout 122 which shows, in this example, Room 1, Room 2, a Hallway, and an Outdoor Area. Networked lighting control devices 22, 24, 26, 28, 30, 32, 34 and 36 are shown at appropriate locations throughout the building layout. The user may select any of the lighting control devices by clicking on the associated icon. Once selected, the icon is highlighted, or blinks, as shown for lighting control device 34. This causes the configuration software to send a location identification flag to the selected networked lighting control device, which then flashes the lights it controls or some other form of visual or audio indicator to disclose its location in actual building premises. When the user identifies the true location of the lighting control device or the apparatus it controls, the user may drag and drop the blinking icon to the corresponding location in the building layout on the screen. Alternatively, the configuration software may suggest the correct location for the icon based on information obtained from the GPS unit or other automated location determination apparatus if the handheld unit is close to the selected lighting control device. If this information is correct, the user may simply click a screen button to accept the suggested location, otherwise, the user may manually move the icon to the correct location.

When a lighting control device is selected, the configuration software may also open a dialog box 124 to display information and/or enable the user to enter information about the selected lighting control device. For example, the dialog box may display the device type, location identification information, network address, etc. for the selected lighting control device. The dialog box may also enable the user to manually override any of this information. Alternatively, the information displayed in the dialog box may be displayed within or close to the corresponding icon on the building layout.

The commissioning software may also perform a commissioning process in which networked input devices are associated with the loads they are intended to control, and behaviors are programmed into the system. The commissioning process may utilize a screen with a building layout similar to that used for location identification, but the user may be allowed to select multiple lighting control devices to associate them as a functional group. Information on the grouped devices may then be transferred to the master controller.

For example, the user may select an occupancy sensor 26 in Room 1, then select ballast 28 and wall switch 30 to associate them as a group. Then, rather than displaying and allowing input of location identification information, the dialog box 124 may enable the user to enter information that defines the behavior of the three lighting control devices in Room 1. The configuration software in the handheld unit may then transmit a commissioning flag to the microcontroller in each of the selected lighting control devices through their respective RFID tag devices. This may cause the microcontroller in each of the selected lighting control devices to execute a commissioning process in which behavior-based rules are downloaded to each lighting control device through its respective RFID tag device. A potential advantage of this arrangement is that it may provide a valuable and time saving method for commissioning devices. Because this method may be implemented while a commissioning agent is present at the actual location of the devices, it may reduce the likelihood of commissioning errors such as grouping lighting control devices in different rooms.

As with the location identification process, during a commissioning process, the configuration software may enable the user to manually select icons for lighting control devices, or to accept suggestions from the configuration software based on GPS or other automated location information.

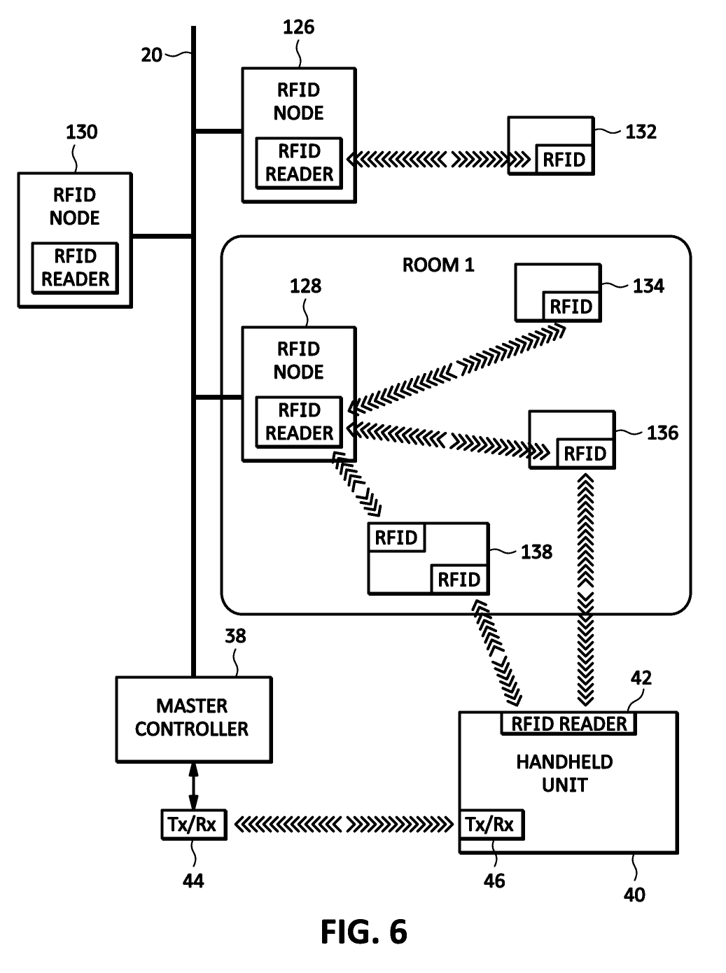

FIG. 6 illustrates another embodiment of a lighting control system according to some inventive principles of this patent disclosure. The embodiment of FIG. 6 includes a network 20 and master controller 38 like the embodiment of FIG. 2. However, some or all of the network connections to the lighting control devices are replaced by connections to nodes 126, 128 and 130, each of which includes an RFID reader device 127, 129 and 131, respectively. These nodes enable the RF connection to the RFID tag devices in the networked lighting control devices 132, 134, 136 and 138 to be used as part of the actual lighting control network. A networked lighting control device may include a single RFID tag device that provides an interface to both the network, and an RFID reader device in a handheld unit as shown for devices 132, 134 and 136. Alternatively, a lighting control device may include two or more RFID tag devices as shown for device 138, wherein one RFID tag device may interface with the lighting control network 20, while another RFID tag device may interface with the RFID reader device in a handheld unit.

RFID tag devices are not intended to implement real-time control because of the relatively slow data transmission rates compared to control networks. However, because the devices on a lighting control network may be tolerant of relatively slow data rates, the inventive principles may enable the implementation of a lighting control network using inexpensive RFID tag devices as part of the network structure, thereby providing a low-cost solution.

The inventive principles of this patent disclosure have been described above with reference to some specific example embodiments, but these embodiments can be modified in arrangement and detail without departing from the inventive concepts. For example, some of the embodiments described above are illustrated in the context of lighting control systems, but the inventive principles may be applied to HVAC systems, security systems, etc. As a further example, much of the logic and functionality in the embodiments described above is described in the context of a software implementation, but any of the functionality may also be implemented with analog and/or digital hardware, software, firmware, or any suitable combination thereof. Such changes and modifications are considered to fall within the scope of the following claims.

1. A networked lighting control device comprising:
lighting control apparatus;
a controller to control the operation of the lighting control apparatus;
a network interface to couple the controller to a lighting control network; and
an RFID tag device to couple the controller to an RFID reader device.

2. The networked lighting control device of claim 1 further comprising logic to perform a visual indication process in response to a request received by the RFID tag device.

3. The networked lighting control device of claim 2 where the visual indication process includes flashing a light controlled by the networked lighting control device.

4. The networked lighting control device of claim 2 where the visual indication process includes flashing an indicator on the networked lighting control device.

5. The networked lighting control device of claim 1 further comprising logic to store location identification information received through the RFID tag device.

6. The networked lighting control device of claim 5 further comprising logic to transmit the location identification information to a master controller through the network interface.

7. The networked lighting control device of claim 1 further comprising logic to:
read a UID from the RFID tag device; and
transmit the UID to a master controller through the network interface.

8. The networked lighting control device of claim 7 further comprising logic to receive a network address from the master controller through the network interface in response to the UID.

9. The networked lighting control device of claim 1 further comprising logic to receive and use commissioning information through the RFID tag device.

10. The networked lighting control device of claim 1 wherein:
the networked lighting control device comprises an occupancy sensor; and
the lighting control apparatus includes one or more sensor circuits.

11. The networked lighting control device of claim 1 wherein:
the networked lighting control device comprises an electronic ballast; and
the lighting control apparatus includes an input stage and an inverter.

12. A method for configuring a networked lighting control system, the method comprising:
providing a networked lighting control device having a network interface and an RFID tag device;
reading the RFID tag device with an RFID reader device in a mobile unit;
determining the location of the networked lighting control device at the mobile unit; and
displaying the location of the networked lighting control device at the mobile unit.

13. The method of claim 12 wherein the location of the networked lighting control device is determined using a GPS unit.

14. The method of claim 12 further comprising transmitting a request for a location identification process to the networked lighting control device through the RFID reader device and the RFID tag device.

15. The method of claim 14 further comprising enabling a user to correct the location of the networked lighting control device at the mobile unit in response to the location identification process.

16. The method of claim 12 further comprising transmitting location identification information to the networked lighting control device through the RFID reader device and the RFID tag device.

17. The method of claim 16 further comprising transmitting the location identification information to a master controller through the network interface on the networked lighting control device.

18. The method of claim 16 wherein the networked lighting control device transmits location identification information to a master controller at the request of the handheld unit.

19. The method of claim 12 further comprising:
providing multiple networked lighting control devices, each device having a network interface and an RFID tag device;
reading the RFID tag devices of the multiple networked lighting control devices with the RFID reader device in the mobile unit;
determining the locations of the multiple networked lighting control devices at the mobile unit; and
displaying the locations of the multiple networked lighting control devices at the mobile unit.

20. The method of claim 19 further comprising grouping two or more of the networked lighting control devices at the mobile unit.

21. The method of claim 20 further comprising transmitting information about the grouped networked lighting control devices to a master controller in the networked lighting control system.

22. A system comprising:
a lighting control network;
a master controller coupled to the network to control network traffic and configuration;
one or more RFID nodes coupled to the network, each RFID node including an RFID reader device; and
one or more networked lighting control devices, each networked lighting control device including an RFID tag device to establish an RF connection with a corresponding RFID reader device at one of the RFID nodes;
wherein the RF connection between each RFID tag device and a corresponding RFID reader device is configured to operate as part of the lighting control network.

23. The system of claim 22 wherein at least one of the networked lighting control devices is configured to perform a configuration operation by communicate with an RFID reader device on a mobile unit through its RFID tag device.

24. The system of claim 22 wherein:
at least one of the networked lighting control devices includes a second RFID tag device; and
the at least one of the networked lighting control devices is configured to perform a configuration operation by communicate with an RFID reader device on a mobile unit through the second RFID tag device.
